(19) United States
(12) Patent Application Publication
(10) Pub. No.: US 2005/0027605 A1
(43) Pub. Date: Feb. 3, 2005

(54) Method and system for shopping-cart identification

(76) Inventors: Xiaochuen Chen, Sunnyvale, CA (US); Michael Chew, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/633,101

(22) Filed: Jul. 31, 2003

(51) Int. Cl. G06F 17/60

(52) U.S. Cl. 705/26

(57) ABSTRACT

System and method for maintaining a persistent-shopping-cart catalog. An embodiment of the invention is directed to a system and method for offering an item for sale on a website, allowing a user to browse the website via a client computer, generating a shopping cart, allowing the user to place the item in the shopping cart, and storing information about the item and the user in a single memory location in response to the browsing session being interrupted.

### BACKGROUND OF THE INVENTION

A “shopping cart” is a well-known feature of conventional commercial websites, where a customer may choose items to purchase by “placing” such items into the shopping cart. By placing an item in the shopping cart, the customer causes the server computer (the computer hosting the commercial website) to store the chosen item in a database and to associate the customer with the chosen item. At any time during the browsing session, the customer may select (mouse click, for example) an icon (typically an icon designed to resemble a shopping cart) to display the list of items in the shopping cart, i.e., all items chosen to be purchased. Further, at any time during the browsing session, the customer may proceed to a checkout page wherein the items in the shopping cart may be purchased and shipped to a desired location.

Typically, the server computer hosting the website also maintains a database of information about registered customers. This information, such as, shipping address, preferred payment method, past purchases, etc., which is collectively known as a user profile, is stored in a customer database. The user profile provides the customer with the benefit of not having to enter redundant information into the website each time a purchase is made.

Another common feature of conventional websites is a “cookie” identification system. A cookie, also well-known in the industry, is a file stored on a remote computer (i.e., the computer that the customer is using to browse the website) that contains information about the commercial website, information about the remote computer, and/or information about the customer. The purpose of a cookie is to allow the server computer to retrieve the identity of the remote computer and/or customer and other information stored with the retrieved cookie when the customer logs onto the server. As such, cookies can be used in conjunction with shopping carts to provide better service to registered customers. The preceding features of a conventional commercial website are discussed in greater detail below with respect to FIG. 1.

FIG. 1 is a block diagram of a system 100 wherein a server computer 110 and a remote computer 150 are communicatively coupled via a network connection such as the internet 105 as shown. Other network connections are practicable, such as, for example, a Local Area Network (LAN), however, the internet 105 will suffice for the discussion here.

The server computer 110 includes a CPU 115 coupled to a bus 116 that facilitates communication between the CPU 115 and other components of the server computer 110. Other components of the server computer 110 include a Network Interface Component 111 (N IC), a memory for a product database 121, a memory for a customer database 122, and a memory for web-server software 120. The NIC 111 facilitates communications between the server computer 110 and other computers, such as remote computer 150, via the internet 105. Although shown as separate components, the product database 121, the customer database 122, and the web server software 120 may reside in a single memory component or in any combination of memory components that are coupled with the bus 116. Alternatively, the product and/or customer databases 121 and 122 may be located external to the server computer 110.

The remote computer 150 also includes a CPU 155 coupled to a bus 156 that facilitates communication between the CPU 155 and other components of the remote computer 150. Other components of the remote computer 150 include a NIC 151, a memory for a cookie database 161, and a memory for web browser software 160. Again, although shown as separate components, the cookie database 161 and the web browser software 160 may reside in a single memory component or in any combination of memory components that are coupled with the bus 156. As was the case with the server computer 110, the NIC 151 facilitates communications between the remote computer 150 and other computers, such as server computer 110, via the internet 105. The operation of the preceding system is described below in conjunction with FIG. 2.

FIG. 2 is a flow diagram of a conventional method for retrieving and using cookies between a server computer 110 and a remote computer 150. When a customer first browses the website at step 201, the server computer 110 attempts to retrieve a cookie associated with the commercial website by sending a request to the remote computer 150 at step 203. The remote computer 150 then checks the cookie database 161 for the requested cookie (associated with this particular commercial website) at step 205.

If the requested cookie is not found in the cookie database 161, the remote computer responds with a message indicating that no matching cookie has been found. The server computer 110 may then display a standard welcoming message for a new user at step 221 and the cookie retrieval methods then ends at step 223. By not retrieving the requested cookie, the server computer 110 is unable to identify the remote computer 150 without additional customer input.

If, however, the requested cookie is found in the cookie database 161, the remote computer 150 sends a copy of the requested cookie back to the server computer 110. Then, at step 207, the server computer 110 accesses the customer database 122 to retrieve information from the user profile about the customer that is associated with the retrieved cookie. The retrieved information may be used, at step 209, to display a customized welcoming message and to place previously stored shopping cart items back into the shopping cart for this browsing session. For example, if a customer has placed a hammer in his/her shopping cart during a previous browsing session, but did not complete the purchase, then the hammer will be retrieved from the customer database (since it was stored there when the customer first chose the item) and will consequently appear in the shopping cart.

The server computer 110 then accesses a second database, the product database 121 at step 211, to retrieve information about the items that have been restored to the shopping cart. Examples of this information include inventory quantity, current purchase price, etc. The server computer 110 may then use this retrieved product information, at step 213, for display in the shopping cart. For example, the previously mentioned hammer (already restored to the shopping cart) is accessed in the product database. Then information about the current price of the hammer and the quantity of hammers available is retrieved for display on the shopping cart web page. The cookie retrieval method then ends at step 223.

One problem associated with the conventional method of FIG. 2 is that the server computer 110 accesses two different databases each time a shopping cart is restored. That is, the server computer 110 accesses the customer database 122 to retrieve the shopping cart information associated with the retrieved cookie and then accesses the product database 121 to retrieve the product information associated with the items retrieved for the shopping cart. This is undesirable because accessing two different databases takes valuable computing time, and thus, may create a delay that is noticeable to the customer.

Another problem is that if the customer browses the website on a computer other than the customer's own remote computer 120 that has the proper cookie stored therein, the customer's shopping cart cannot be retrieved because the proper cookie cannot be retrieved. As such, the customer must re-select all the items that were in his/her shopping cart when he/she last disconnected from the server computer 110. Furthermore, customers who have yet to establish a user profile (thus, establishing a cookie on their remote computer) will also have to reselect items in their shopping cart is disconnected.

### SUMMARY OF THE INVENTION

An embodiment of the invention is directed to a system and method for offering an item for sale on a website, allowing a user to browse the website via a client computer, generating a shopping cart, allowing the user to place the item in the shopping cart, and storing information about the item and the user in a single memory location in response to the browsing session being interrupted. Another embodiment of the invention is directed to a system and method is directed to allowing a user to browse a website via a client computer, determining whether the user has a shopping cart from a previous browser session, retrieving shopping-cart information from a single memory location if the user has a shopping cart from a previous browser session, and regenerating the shopping cart from the retrieved shopping-cart information.

Yet another embodiment of the invention is directed to a data carrier having computer-executable instructions operable to offer an item for sale on a downloadable webpage, to allow a user to browse the webpage via a client computer, generate a shopping cart for display on the client computer, to allow the user to place the item in the shopping cart, and to store information about the item and the user in a single memory location in response to the browsing session being interrupted.

### BRIEF DESCRIPTION OF THE DRAWINGS

The foregoing aspects and many of the attendant advantages of this invention will become more readily appreciated as the same become better understood by reference to the following non-limiting detailed description, when taken in conjunction with the accompanying drawings, wherein:

FIG. 1 is a block diagram of a conventional system wherein a commercial-website server computer and a remote computer are communicatively coupled via a network connection;

FIG. 2 is a flow diagram of a conventional method for retrieving and using cookies between the server computer and the remote computer of FIG. 1;

FIG. 3 is a block diagram of a commercial-website server computer using a plug-in software component according to an embodiment of the invention; and

FIG. 4 is a flow diagram of a method for retrieving and using cookies between the server computer and the remote computer of FIG. 3 according to an embodiment of the invention.

### DETAILED DESCRIPTION

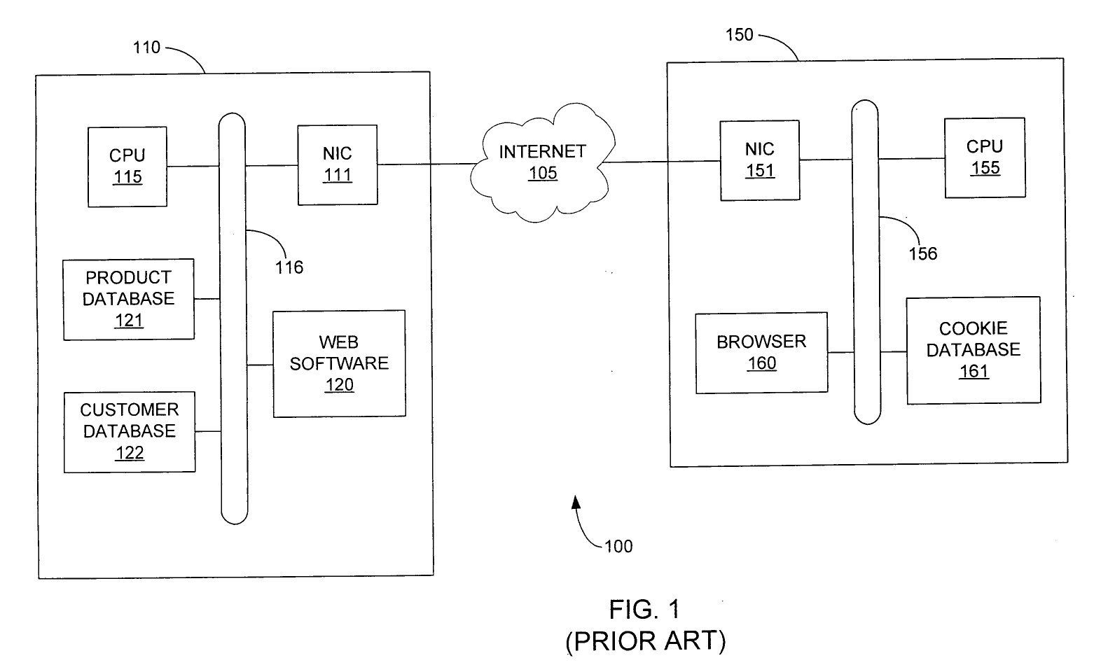

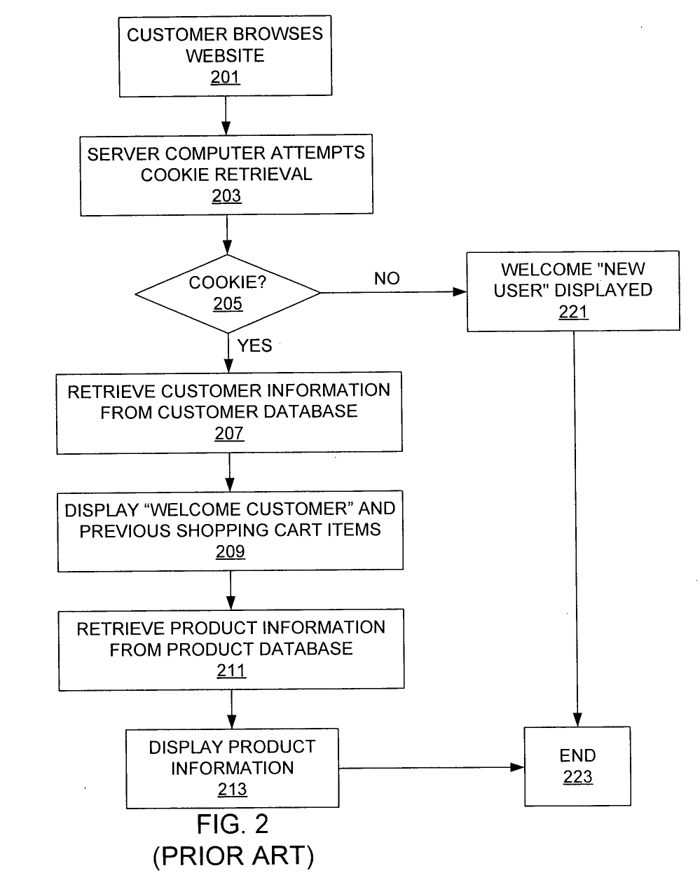

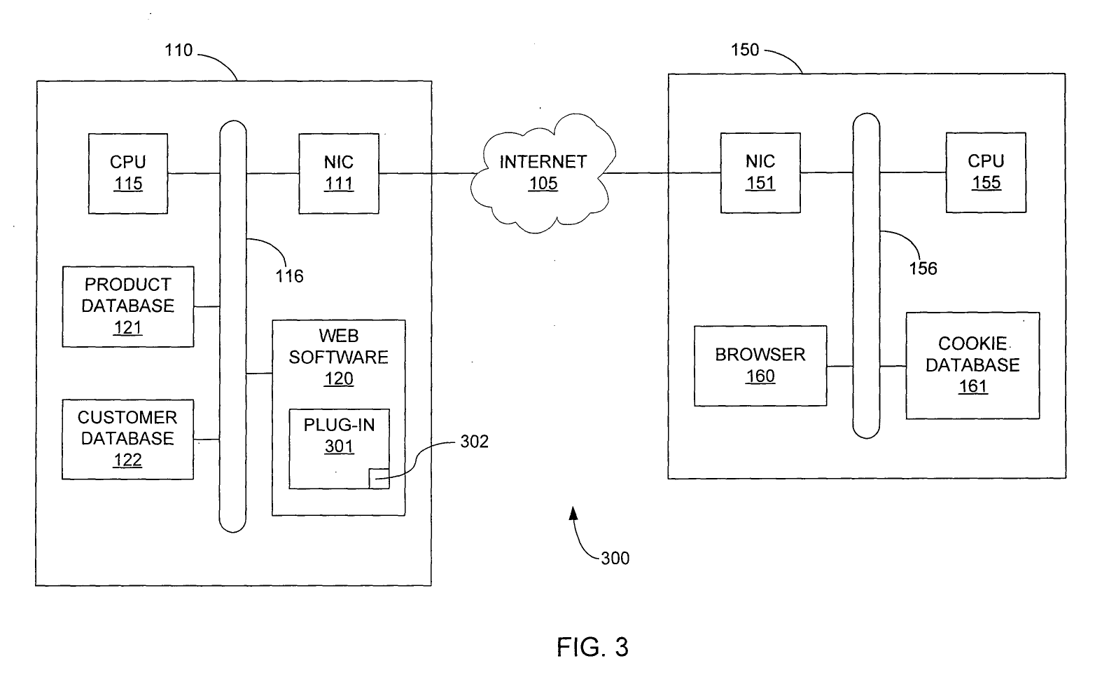

FIG. 3 is a block diagram of a commercial-website computer system 300 having a plug-in software component 301 according to an embodiment of the invention. The components of the system 300 are similar to the components of the system 100 described above with respect to FIG. 1 (thus, the same reference numbers are also used), however, the system 300 of FIG. 2 includes a plug-in software component 301 that alters the way in which the shopping browsing session is handled between the remote computer 150 and the server computer 110. By using a plug-in 301, one can modify the web software 120 without rewriting the entire program.

The plug-in 301, which is resident within the web software 120, effectively provides a persistent-shopping-cart catalog 302 that stores information about both a customer and products in his/her shopping cart. Each customer/shopping cart entry in the catalog 302 is identified by a unique shopping-cart identification. Thus, each customer who is currently shopping is associated with a shopping-cart identification in the catalog 302. Further, as the customer places products in his/her shopping cart, information about the products is retrieved from the product database 121 and stored in the catalog 302 and is associated with the customer's shopping-cart identification. Thus, if a customer's session ends before he/she empties his/her shopping cart, the plug-in 301 stores the customer's shopping-cart identification and information about the product's in the customer's shopping cart in the catalog 302. Then, if the customer returns to the website, the information about products in the shopping cart can be quickly retrieved since the information is still resident within the catalog 302 of the plug-in 301.

The software 120 can typically regenerate the customer's shopping cart from the catalog 302 more quickly that if it had to access the product database 121 and/or the customer database 122. As discussed below, the plug-in 301 can, however, update the information regarding the products in the shopping cart from the database 121 when the customer logs back on to the website. Alternatively, the plug-in 301 can update the information at regular intervals. Furthermore, the plug-in 301 can perform the updating shortly after the customer logs back into the website so that any delay associated with the update is less noticeable to the customer. The plug-in 302 will typically store the information about products in a customer's shopping cart and associate that information with the customer's shopping-cart identification for a limited amount of time. For example, the plug-in 301 may store the information in the catalog 302 for 24 hours during which time the customer may return to the website and the shopping cart can quickly be restored. After 24 hours, the plug-in 301 may purge the information stored in the catalog 302 to allow additional storage space for other information relating to other customer's shopping carts to be stored.

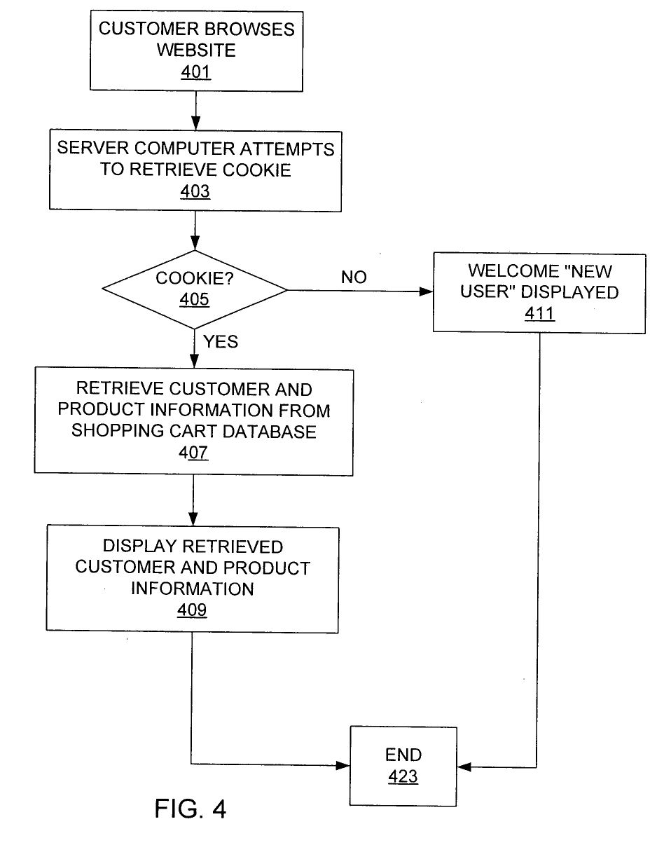

Also, as discussed below, if the customer logs onto the website from a remote computer 150 that did not store a cookie for the last transaction, the plug-in 301 can still generate the customer's shopping cart once the customer enters identifying information, such as name, address and/or customer log-in name and password. The operation of the preceding system is further described below in conjunction with FIG. 4.

FIG. 4 is a flow diagram of a method for retrieving and using cookies between a server computer 110 and a remote computer 150 according to an embodiment of the invention. When a customer first browses the website at step 401, the server computer 110 attempts to retrieve a cookie associated with the website by sending a request to the remote computer 150 at step 403. The remote computer 150 then checks the cookie database 161 for the requested cookie (associated with this particular website) at step 405.

If the requested cookie is not found in the cookie database 161, the remote computer responds with a message indicating that no matching cookie has been found. The server computer 110 may then display a standard welcoming message for a new user.

If, however, the requested cookie is found in the cookie database 161, the remote computer 150 sends a copy of the requested cookie back to the server computer 110. Then, at step 407, the server computer 110 accesses the catalog 302 to retrieve information about the customer and information about the items in the associated shopping cart. This retrieved information may be used, at step 409, to display a customized welcoming message and to place previously stored shopping cart items back into the shopping cart for this browsing session and to display product information about the items in the shopping cart. For example, the previously mentioned hammer is associated with the shopping-cart identification, the user profile and product information in the catalog 302. Then, when the customer is identified by retrieving the cookie having the customer's shopping-cart identification, the shopping cart web page displays the hammer, its price, its quantity available, and user profile information, all of which is retrieved from the catalog 302. Having only accessed a single database, the cookie retrieval method then ends at step 223.

Referring to FIG. 3, the plug-in 301 is capable of storing a variety of different pieces of information about products and customers in the catalog 302. As a customer browses the website and selects different products to be placed in the shopping cart, the plug-in 301 may update the catalog 302 to reflect the changes. For example, each product available on the commercial website typically has an associated product description that is stored in the product database 121. Once a product is selected to be in a shopping cart, the product description may be copied and stored in the catalog 302 along with the product identification, both of which are associated with the shopping-cart identification and the customer's profile. By storing the product information in the catalog 302, the web software 120 does not need to access the product database 121 when restoring the shopping cart.

The plug-in 301 may store additional information in the catalog 302 for a particular shopping-cart identification. For example, the stock level of a product may be stored in the catalog 302 when the customer logs off or is timed out of the website. Furthermore, the plug-in 301 may update the stock level (how many of that product are in stock) by checking the product database 121 at regular intervals even while the customer is not logged in to the website such that when the customer returns to the website, the catalog 302 reflects the correct stock level. The plug-in 301 may also update and store the product price in a similar manner.

The preceding discussion is presented to enable a person skilled in the art to make and use the invention. The general principles described herein may be applied to embodiments and applications other than those detailed below without departing from the spirit and scope of the present invention. The present invention is not intended to be limited to the embodiments shown, but is to be accorded the widest scope consistent with the principles and features disclosed or suggested herein.

1. A method, comprising:
offering an item for sale on a website;
allowing a user to browse the website via a client computer;
generating a shopping cart;
allowing the user to place the item in the shopping cart; and
storing information about the item and the user in a single memory location in response to the browsing session being interrupted.

2. The method of claim 1, further comprising:
allowing the user to resume the interrupted browsing session;
identifying the user;
retrieving the information about the item from the single memory location in response to identifying the user; and
restoring the shopping cart from the retrieved information.

3. The method of claim 2 wherein identifying the user comprises retrieving a cookie from the client computer.

4. The method of claim 2 wherein identifying the user comprises identifying the user from information the user enters via the client computer.

5. The method of claim 1 wherein restoring the shopping cart comprises displaying information associated with the item and information associated with the user.

6. The method of claim 1 wherein storing information about the user comprises storing on the client computer a cookie operable to identify the client computer.

7. The method of claim 1 wherein storing information about the user comprises storing a cookie on the client computer in response to the user placing the item in the shopping cart, the cookie operable to identify the client computer.

8. The method of claim 1, further comprising deleting the information about the item and the user after a predetermined time period.

9. A server, comprising:
a memory;
a processor coupled to the memory and operable to execute a component of a software application, and, in response to the component, to,
generate a website that offers an item for sale,
allow a user to browse the website via a client computer,
generate a shopping cart,
allow the user to select the item for purchase by placing the item in the shopping cart, and
store in the memory information about the item and the user in response to the browsing session being interrupted.

10. The server of claim 9 where in response to the software component, the processor is further operable to store a cookie on the client computer during the browsing session, the cookie including the information about the user.

11. The server of claim 9 where in response to the software component, the processor is further operable to store a cookie on the client computer in response to the user placing the item into the shopping cart, the cookie including the information about the user.

12. The server of claim 9 wherein the software component comprises a plug-in software component.

13. The server of claim 9 wherein the information about the user comprises a name of the user.

14. The server of claim 9 wherein the information about the user comprises information about the client computer.

15. The server of claim 9 wherein the information about the item comprises a description of the item.

16. The server of claim 9 wherein the information about the item comprises an inventory level of the item.

17. The server of claim 9 wherein the information about the item comprises a price of the item.

18. A method, comprising:
allowing a user to browse a website via a client computer;
determining whether the user has a shopping cart from a previous browser session;
retrieving shopping-cart information from a single memory location if the user has a shopping cart from a previous browser session; and
regenerating the shopping cart from the retrieved shopping-cart information.

19. The method of claim 18, further comprising updating the regenerated shopping cart.

20. The method of claim 18 wherein regenerating the shopping cart comprises including an item that the user placed in the shopping cart during the previous browser session.

21. The method of claim 18 wherein determining whether the user has a shopping cart from a previous browser session comprises determining if there is a stored shopping cart associated with the client computer.

22. The method of claim 18 wherein determining whether the user has a shopping cart from a previous browser session comprises determining if there is a stored shopping cart associated with the user.

23. A server, comprising:
a memory;
a processor coupled to the memory and operable to execute a component of a software application, and, in response to the component, to,
allow a user to browse a website via a client computer,
determine whether the user has a shopping cart from a previous browser session,
retrieve shopping-cart information from the memory if the user has a shopping cart from a previous browser session, and
regenerate the shopping cart from the retrieved shopping-cart information.

24. A system, comprising:
a client computer;
a server operable to be coupled to the client computer and including,
a memory,
a processor coupled to the memory and operable to execute a component of a software application, and, in response to the component, to,
generate a website that offers an item for sale,
allow a user to establish a first browsing session on the website via the client computer,
generate a shopping cart,
allow the user to select the item for purchase by placing the item in the shopping cart,
store in the memory information about the item and the user in response to the first browsing session being interrupted,
allow the user to establish a second browsing session on the website,
determine during the second browsing session that the user has a shopping cart from the first browsing session, and
regenerate the shopping cart from the information about the item stored in the memory.

25. The system of claim 24 wherein the processor is operable to determine that the user has a shopping cart from the first browsing session by comparing information received about the user during the second browsing session with the information about the user stored in the memory in response to the first browsing session being interrupted.

26. The system of claim 24 wherein:
the information stored about the user includes information about the client computer; and
the processor is operable to determine that the user has a shopping cart from the first browsing session by comparing information received about the client computer during the second browsing session with the information about the client computer stored in the memory in response to the first browsing session being interrupted.

27. A data carrier having computer-executable instructions operable to:
offer an item for sale on a downloadable webpage;
allow a user to browse the webpage via a client computer;
generate a shopping cart for display on the client computer;
allow the user to place the item in the shopping cart; and
store information about the item and the user in a single memory location in response to the browsing session being interrupted.

28. The data carrier of claim 27 comprising one or more TCP/IP packets.

29. The data carrier of claim 27 comprising an object-oriented process.

30. A computer-readable medium having computer-executable instructions operable to:
offer an item for sale on a downloadable webpage;
allow a user to browse the webpage via a client computer;
generate a shopping cart for display on the client computer;
allow the user to place the item in the shopping cart; and
store information about the item and the user in a single memory location in response to the browsing session being interrupted.
